(19) United States
(12) Patent Application Publication
(10) Pub. No.: US 2011/0231762 A1
(43) Pub. Date: Sep. 22, 2011

(54) PLAY LIST GENERATING APPARATUS, PLAYLIST GENERATING METHOD, PLAYLIST GENERATING PROGRAM, AND RECORDING MEDIUM

(75) Inventor: Maki Toida, Kokubunji (JP)

(73) Assignee: PIONEER CORPORATION, Tokyo (JP)

(21) Appl. No.: 13/119,569

(22) PCT Filed: Oct. 30, 2009
(86) PCT No.: PCT/JP2009/068720

§ 371 Date: Mar. 17, 2011

(51) Int. Cl. G06F 3/048

(52) U.S. Cl. 715/716

(57) ABSTRACT

A playlist generation apparatus extracts given content items from a content group, generates a playlist, and includes an application information acquiring unit that acquires information related to an application running on an information processing terminal possessed by a user viewing/listening to the content items; a setting unit that receives setup-input for setting a priority level, for each application running on the information processing terminal; and a generating unit that based on the set priority levels and the information related to an application running, extracts from the content group, the content items to constitute the playlist and generates the playlist.

### TECHNICAL FIELD

The present invention relates to a playlist generating apparatus, a playlist generating method, a playlist generating program, and recording medium that generate a playlist prescribing the sequence in which content is to be played. Nonetheless, application of the present invention is not limited to the playlist generating apparatus, the playlist generating method, the playlist generating program, and the recording medium.

### BACKGROUND ART

Conventionally, content on various types of media can be viewed and listened to irrespective of the time and place as a result of improvements in the performance of content output apparatuses, the increased capacities and decreased sizes of recording apparatuses, provision of networks, etc. Although the increase in usable content offers the benefit of a wide selection of viewable content, selection can be difficult at times. To address such problems, a known technology, for example, automatically generates a playlist indicating a sequence in which content is to be played (see for example, Patent Document 1 below). According to Patent Document 1, a playlist reflecting user preference is automatically generated based on information such as the frequency of content playback.

Patent Document 1: Japanese Patent Application Laid-Open Publication No. 2008-204506

### DISCLOSURE OF INVENTION

### Problem to be Solved by the Invention

Nevertheless, the mood of the user, circumstances, etc. vary each occasion content is to be viewed and/or listened to, and content of interest varies among users. Recently in particular, with continuous network connection having become possible due to the widespread use of mobile terminals, it is highly likely that user demands will dynamically change even while content is being viewed or listened to. Although the aforementioned technology is capable of generating a playlist according to user preference in general, a problem arises in that, for example, the technology is incapable of generating a playlist that dynamically suits the mood of the user, circumstances, etc. Meanwhile, for example, a problem further arises in that to generate a playlist dynamically reflecting the mood of the user, content must be selected one by one from among a vast number of content items, a complicated task.

### Means for Solving Problem

To solve the problems above and achieve an object, a playlist generation apparatus according to the invention of claim 1, extracts given content items from a content group and generates a playlist. The apparatus includes an application information acquiring unit that acquires information related to an application running on an information processing terminal possessed by a user viewing/listening to the content items; a setting unit that receives setup-input for setting a priority level, for each application running on the information processing terminal; and a generating unit that based on the set priority levels and the information related to an application running, extracts from the content group, the content items to constitute the playlist and generates the playlist.

Further a playlist generating method according to the invention of claim 12 is a method of extracting given content items from a content group and generating a playlist at a playlist generating apparatus. The playlist generating method includes acquiring information related to an application running on an information processing terminal possessed by a user viewing/listening to the content items; receiving setup-input for setting a priority level, for each application running on the information processing terminal; and extracting from the content group and based on the set priority levels and the information related to an application running, the content items to constitute the playlist in generating the playlist.

A playlist generating program according to the invention of claim 13 causes a computer to execute the playlist generating method according to claim 12.

A computer-readable recording medium according to the invention of claim 14 stores therein the playlist generating program according to claim 13.

### BRIEF DESCRIPTION OF DRAWINGS

FIG. 1 is a block diagram of a functional configuration of a playlist generating apparatus according to an embodiment;

FIG. 2 is a flowchart of a procedure of a playlist generation process by the playlist generating apparatus;

FIG. 3 is a system configuration diagram for a content output system;

FIG. 4 is a block diagram of a hardware configuration of the navigation apparatus;

FIG. 5 is one example of an output screen of the navigation apparatus;

FIG. 6 is a diagram of one example of a setup screen for widget priority levels; and

FIG. 7 is a flowchart depicting a procedure of the playlist generation processing executed by the navigation apparatus.

### BEST MODE(S) FOR CARRYING OUT THE INVENTION

With reference to the accompanying drawings, a preferred embodiment of a playlist generating apparatus, a playlist generating method, a playlist generating program, and recording medium according to the invention will be described in detail.

### Embodiment

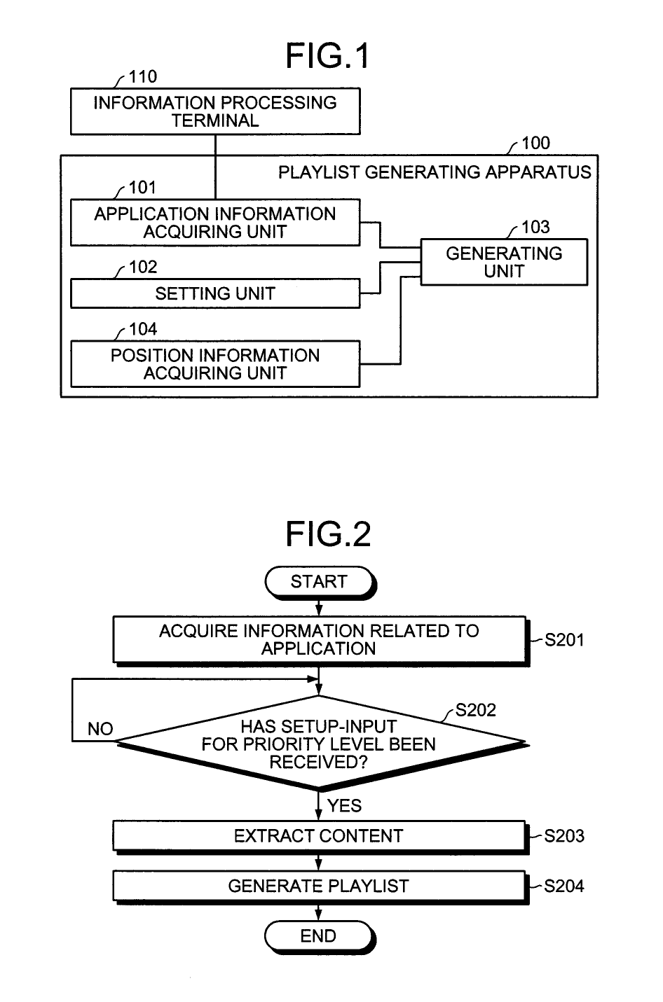

FIG. 1 is a block diagram of a functional configuration of a playlist generating apparatus according to the embodiment. A playlist generating apparatus 100 according to the embodiment extracts given content items from among plural content items in a content group to generate a playlist, and includes an application information acquiring unit 101, a setting unit 102, a generating unit 103, and a position information acquiring unit 104.

A playlist generated by the playlist generating apparatus 100 is used, for example, to prescribe the sequence in which content items are output by a content output apparatus (not depicted). For example, the playlist generating apparatus 100 extracts, from among content items stored in a content output apparatus, given content items (in the present embodiment, content items used by an application having a high priority level) and generates a playlist. Here, content items are, specifically, for example, music, moving images, still images, information services, etc. In the generation of a playlist, the extraction of content items may be limited to content items stored to the same medium or the playlist may include content items irrespective of medium-type.

Further, the content group, for example, may include content stored to a content server communicable with the playlist generating apparatus 100 and the content output apparatus, content distributed over the internet, etc. In the present specification, a content server is not limited to a dedicated server for content storage and may be an apparatus representative of information processing apparatuses having a communication function and a storage apparatus in which at least a portion stores content data.

Further, the content group may include content stored at different storage locations. For example, the content group may include content stored to the content output apparatus, content stored to a communicable content server, and content distributed over the internet. In other words, the playlist generating apparatus 100 may include content items in the playlist irrespective of storage location and content medium, provided the content items can be utilized by a terminal that plays back content items based on the generated playlist.

The application information acquiring unit 101 acquires information related to an application running on an information processing terminal 110 possessed by the user who is to view or listen to content. The information processing terminal 110 is, for example, a portable content output apparatus, a personal computer, a car navigation apparatus, etc. The information processing terminal 110 may be a content output apparatus that plays back content according to the playlist generated by the playlist generating apparatus 100. Further, the information processing terminal 110 and the playlist generating apparatus 100 may be integrated.

Multiple applications can be run simultaneously on the information processing terminal 110. When multiple applications are run on the information processing terminal 110, the application information acquiring unit 101 acquires information for each of the applications. Application related information is, for example, identification information identifying an application (application name, etc.), information provided by the user through an application, information acquired via a network by an application, etc.

For example, if an application running on the information processing terminal 110 is an application using content, the application information acquiring unit 101 acquires information related to the content used by the application. More specifically, if the application is a content management application managing content possessed by the user (hereinafter, “possessed content”), the application information acquiring unit 101 acquires, for example, at least one of the following types of information, viewing/listening frequency information for the possessed content, user evaluation information for the content, procurement route information for the possessed content, and procurement-period information for the possessed content.

Further, if the running application is a viewing/listening application for viewing/listening to internet broadcasts, the application information acquiring unit 101, for example, acquires at least one of the following types of information, information concerning the internet broadcast currently in progress, information concerning content delivered in the past via an internet broadcast, and user evaluation information concerning internet radio delivered content.

If the running application is a viewing/listening application for viewing/listening to content posted on the internet (hereinafter, “posted content”), the application information acquiring unit 101, for example, acquires at least one of the following types of information, evaluation information concerning the posted content, playback frequency information for the posted content, and information concerning keywords correlated with the posted content.

Further, for example, if the application running on the information processing terminal 110 is an application that provides dynamically changing information (hereinafter, “dynamic information”), the application information acquiring unit 101 acquires the dynamic information provided by the application. More specifically, for example, if the running application is for accessing a social network service that builds a network with other people through the internet, the application information acquiring unit 101 acquires at least one of the following types of information, content information introduced to the user by a person in the social network and content information introduced to a person in the social network by the user.

Dynamic information provided by the application may be, for example, current position information concerning the user, local weather information for the current position of the user, current local time information for the user, schedule information for the user, current position information concerning an acquaintance of the user, local weather information for the current position of an acquaintance, current local time information for an acquaintance, schedule information for an acquaintance, etc. The application may provide any one of the aforementioned types of information or may provide multiple types of information. In this case as well, the application information acquiring unit 101 acquires each type of information provided by the application.

The aforementioned application may be, for example, a widget running on the information processing terminal 110. A widget represents small-scale accessory software operating on the desktop of the information processing terminal 110 or by another application. A widget continuously runs on the desktop, acquires information as needed through the internet, and provides the information to the user. A widget used by the user often includes a function that reflects the preferences and lifestyle of the user, daily plans, etc. Consequently, by acquiring widget related information, real-time information related to the preferences and lifestyle of the user, daily plans, etc. can be obtained, enabling generation of a playlist suiting the needs of the user.

The setting unit 102 receives setup-input for setting a priority level, for each application running on the information processing terminal 110. The setting unit 102, for example, elicits input of a priority level, as a numeric value, for each running application, displays slide-bars, such as that for an equalizer, with respect to each application and elicits adjustment of the position of the slide bars to receive setup-input.

The generating unit 103 extracts content items from the content group, based on the information related to the application running on the information processing terminal 110 and the priority level set at the setting unit 102. The generating unit 103, for example, preferentially uses information related to an application for which a high priority level has been set via the setting unit 102 and extracts content items. More specifically, if the application is an application having a high priority level and using content, information concerning the content used by the application is preferentially used to extract content items. Further, if the application has a high priority level and provides dynamic information, the generating unit 103 preferentially extracts content items related to the dynamic information provided by the application.

Herein, one example of a content extraction method that uses various types of information and is executed by the generating unit 103 will be described. If viewing/listening frequency information for possessed content is used, the generating unit 103, for example, extracts possessed content items having a high viewing frequency. If user evaluation information for the possessed content is used, the generating unit 103, for example, extracts possessed content items having a high user evaluation. If procurement route information is used, the generating unit 103, for example, extracts possessed content obtained by a particular route (for example, “borrowed from a friend”, “downloaded from a website selling content”, etc.). If procurement-period information is used, the generating unit 103, for example, extracts possessed content obtained during a particular period (for example, “yesterday”, “December of last year”, etc.).

Further, if information for content currently being broadcast on the internet is used, the generating unit 103, for example, extracts content items by the same artist of the content current being broadcast on the internet. If information for content broadcast on the internet in the past is used, the generating unit 103, for example, extracts content items identical to content broadcast during a specified period. If user evaluation information for content broadcast over the internet is used, the generating unit 103, for example, extracts content items having a high user evaluation.

Further, if evaluation information concerning posted content on the internet is used, the generating unit 103, for example, extracts content items having a high evaluation. Further, if playback frequency information for the posted content is used, the generating unit 103 extracts content items having a high frequency of playback. If information concerning keywords correlated with the posted content is used, the generating unit 103, for example, extracts content items correlated with specified keywords (for example, the name of a location, person, journal, etc.).

If content information introduced to the user by another person in the social network or content information introduced by the user is used, the generating unit 103, for example, extracts content items introduced by a designated person or content items introduced to a designated person.

If current position information for the user or an acquaintance is used, the generating unit 103, for example, extracts content items having a theme based on the environs of the current position of the user or the acquaintance, content items by an artist in concert near the current position, etc. If local weather information for the current position of the user or an acquaintance is used, the generating unit 103, for example, extracts content items related to the weather (for example, content having themes such as sunshine, rain, snow, etc.). If current local time information for the user or an acquaintance is used, the generating unit 103 extracts content items related to the current time (for example, content having themes such as morning, night, a specific season, Christmas, etc.). If schedule information for the user or an acquaintance is used, the generating unit 103, for example, extracts content items related to the schedule (for example, content having a theme related to the scheduled plans of the user).

The extraction method above is one example and specifically what type of content is to be extracted is determined according to the relative priority levels among running applications, user preference, etc.

The position information acquiring unit 104 acquires position information for the playlist generating apparatus 100. The position information acquiring unit 104, for example, computes the position information for the playlist generating apparatus 100 from information output from a GPS unit. If position information is acquired by the position information acquiring unit 104, the generating unit 103 generates a playlist, using the position information and application related information. Specifically, for example, the playlist generating apparatus 100 uses content related to the current position of the playlist generating apparatus 100 (content for which the plot-setting is the current position, content by an artist having a connection to the current position, etc.) to generate a playlist.

Next, a playlist generation process by the playlist generating apparatus 100 will be described. FIG. 2 is a flowchart of a procedure of the playlist generation process by the playlist generating apparatus. First, the playlist generating apparatus 100, using the application information acquiring unit 101, acquires information related to the application running on the information processing terminal 110 (step S201). The playlist generating apparatus 100 waits until the setting unit 102 has received setup-input for priority levels of the applications (step S202: NO).

Upon receipt of the setup-input, (step S202: YES), the playlist generating apparatus 100, using the generating unit 103 and based on the priority levels set at step S202 and the application related information acquired at step S201, extracts content items from a content group (step S203). Subsequently, the generating unit 103 determines a playback sequence for the extracted content items and generates a playlist (step S204), ending the process depicted in the flowchart. Subsequently, for example, the generated playlist is presented to the user, where if the user accepts the playlist, output of the content items according to the playlist begins at the content output apparatus. Further, if the user does not accept the playlist, setup-input with respect to the setting unit 102 is again elicited, and the playlist may be regenerated.

As described above, the playlist generating apparatus 100 according to the present embodiment, sets a priority level for applications running on the information processing terminal 110 and generates a playlist based on the priority levels. Thus, without the user designating content items one by one, by a setting operation for the priority levels of the applications alone, a playlist can be obtained reflecting the mood and situation of any occasion.

For example, if an application is an application having a high priority level and uses content, the content used by the application has a high likelihood of being content meeting the preferences of the user at that time. Further, if the application is an application having a high priority level and providing dynamic information, content related to the information provided by the application has a high likelihood of meeting the preferences of the user at that time. The playlist generating apparatus 100, in generating a playlist, without direct designation of keywords by the user, elicits a setting of priority levels with respect to applications, enabling generation of a playlist drawing out non-obvious (ambiguous) needs of the user.

Further, as application related information, by using information in a window used by the user, real-time information related to preferences and the lifestyle of the user, daily plans, etc, can be automatically obtained, enabling generation of a suitable playlist from user needs. Further, upon generation of the playlist, by using position information for the information processing terminal 110, a playlist meeting changes in the circumstances of the user in real-time can be generated.

### EXAMPLE

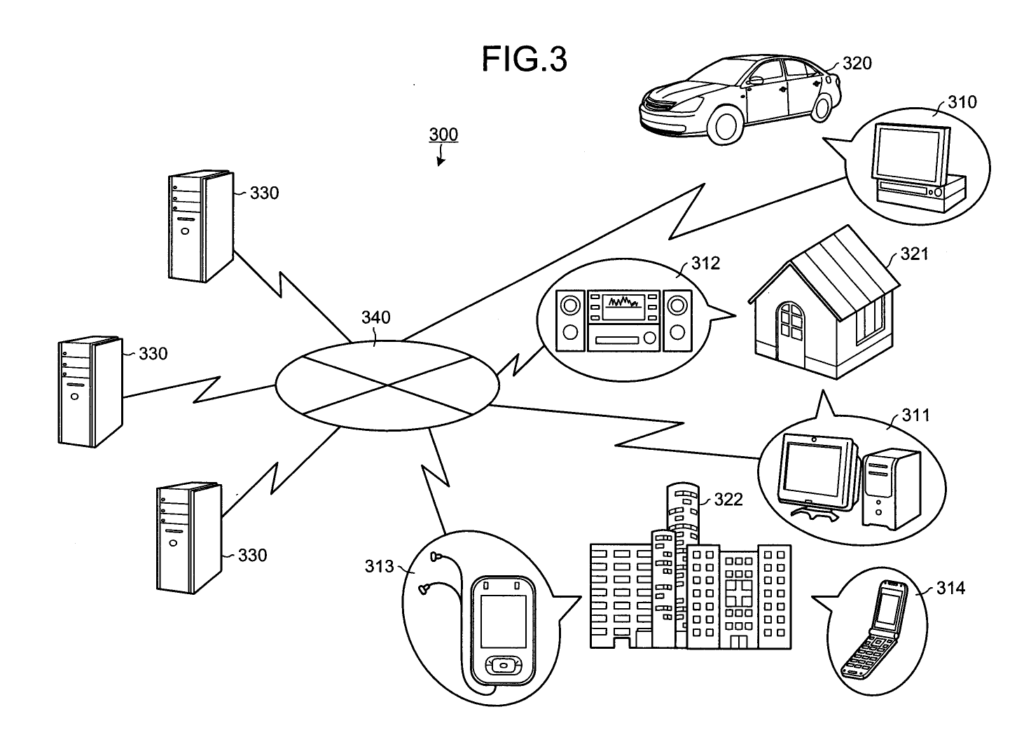

Herein, an example of the present invention will be described. FIG. 3 is a system configuration diagram for a content output system. In the present example, an application of the present invention is described in which a navigation apparatus 310 in a content output system 300 is applied as the playlist generating apparatus 100. In the present example, the playlist generating apparatus 100 is integrated with the navigation apparatus 310. Further, the information processing terminal 110 is the navigation apparatus 310 itself.

### (Configuration of Content Output System 300)

The content output system 300 includes content output apparatuses, such as the navigation apparatus 310, a personal computer 311, a stereo system 312, a portable audio player 313, a cellular telephone terminal 314, etc., respectively connected to a network 340 and an information management server 330. The content output apparatus, in addition to that possessed by the user, includes that possessed by others capable of exchanging content output information with the user such as acquaintances of the user

Each of the installation locations for the above content output apparatuses are given as examples and the apparatuses may be installed at other locations. For example, the portable audio player 313 may be used for content output inside the vehicle 320, a portion of the navigation apparatus 310 (a unit inclusive of a recording medium) may be brought inside the home 321 for content output or to transport content data.

The information management server 330 is a server managed by various application providers, internet community managers, etc. The information management server 330, for example, manages the viewing/listening of content by a user of a given application for viewing/listening to the content, manages the activities of a given community to which members belong, etc. A given application is, for example, a widget, i.e., a small-scale application operating on the desktop of an information management terminal. A widget continuously runs on the desktop, acquires information as needed through the internet, and provides the information to the user. Thus, without actively performing an operation to acquire information, the user is able to obtain required information automatically.

Further, a community on a network is called an SNS (social networking service). An SNS is a service for building social networks on the internet 340 or a website, primarily taking the form of a community-modeled, membership based service. Through an SNS, the user is able to exchange messages with other SNS members, post a diary, an evaluation (review) of given content, etc.

The state of content output at the content output apparatuses, such as the navigation apparatus 310, the personal computer 311, the stereo system 312, the portable audio player 313, and the cellular telephone terminal 314, is transmitted to the information management servicer 330 through the application used for content output and through connection to the community to which the user belongs. Further, the user can obtain from the information management server 330, the state of content output by a person (an acquaintance, a member of the same group within the community, etc.) sharing information.

### (Hardware Configuration of Navigation Apparatus 310)

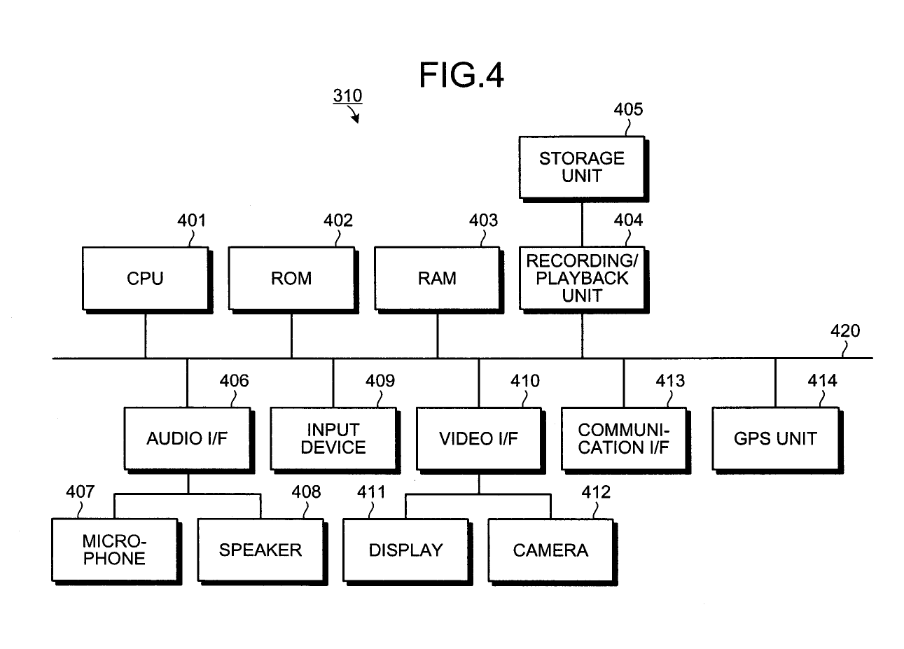

FIG. 4 is a block diagram of a hardware configuration of the navigation apparatus. The navigation apparatus 310 according to the example includes a CPU 401, a ROM 402, a RAM 403, a recording/playback unit 404 that records/plays back various types of data, a storage unit 405 storing various types of data, an audio I/F (interface) 406, a microphone 407, a speaker 408, an input device 409, a video I/F 410, a display 411, a camera 412, a communication I/F 413, and a GPS unit 414, respectively connected by a bus 420.

The CPU 401 governs overall control of the navigation apparatus 310. The ROM 402 stores therein various programs such as a boot program, a content output program, etc. The RAM 403 serves as a work area of the CPU 401. In other words, the CPU 401 uses the RAM 403 as a work area while executing various programs stored to the ROM 402 to govern overall control of the navigation apparatus 310.

The recording/playback unit 404, under the control of the CPU 401, controls the reading and the writing of data with respect to the storage unit 405. The storage unit 405 stores the data written thereto under the control of the recording/playback unit 404. A magnetic disk drive, an optical disk drive, etc. for example may be used as the recording/playback unit 404. An HD (hard disk), an FD (flexible disk), flash memory, an MO, an SSD (Solid State Disk), a memory card, etc. maybe used as the storage unit 405.

Content data and map data can be given as an example of the information stored to the storage unit 405. Content data is, for example, music data, still image data, moving picture data, and the like. In the present example, the content data is music data. The navigation apparatus 310, according to user operation, plays back content data stored in the storage unit 405. In addition to the main data forming the gist of the content data, the content data includes incidental information such as the title of the content, the name of the performer, etc.

Further, map data includes background data indicative of terrestrial objects (features) such as buildings, rivers, ground surfaces, etc, and is organized by region in multiple data files. Map data is, for example, used for route retrieval processing and route guidance processing in the navigation apparatus 310.

The audio I/F 406 is connected to the microphone 407 for audio input and the speaker 408 for audio output. The audio I/F 406 D/A converts and outputs as sound from the speaker 408, audio data designated for playback. The speaker 408 may be detachable from the navigation apparatus 310 or may be located at a position independent of the navigation apparatus 310. The microphone 407, for example, is provided near the sun-visor of the vehicle, captures and outputs to the audio I/F 406, the speech of the user. Audio captured by the microphone 407 is A/D converted at the audio I/F 406.

The input device 409 includes a remote controller, a keyboard, a touch panel and the like, which include keys for inputting text, numeric values, various instructions, etc. The input device 409 may be implemented by one among a remote controller, a key board, and a touch panel, or a combination thereof.

The video I/F 410 is connected to the display 411 and to the camera 412. The video I/F 410, specifically, for example, includes a graphic controller that controls the display 411, a buffer memory such as a VRAM (Video RAM) that temporarily stores immediately displayable image information, and a control IC that controls the display 411 based on image data output from the graphic controller.

The display 411 displays icons, a cursor, menus, windows, or various data such as text and images. If the content output by the navigation apparatus 310 is image data, content images may be displayed on the display 411, the video I/F 410 may connect to another display (for example, a display of a size larger than the display 411 of the navigation apparatus 310) to display the content images.

The camera 412 captures images inside the vehicle 320 equipped with the navigation apparatus 310 or outside the vehicle 320. Images captured by the camera 412 may be still images or moving images and are stored to the storage unit 405 via the video I/F 410.

The communication I/F 413 is wirelessly connected to a network and is capable of transmitting and receiving data via the network. Through the use of the communication I/F 413, the navigation apparatus 310 is able to further acquire content data via networks. Additionally, the communication I/F 413 is equipped with a function of receiving a broadcast wave from a broadcast station.

The GPS unit 414 receives signals from GPS satellites and outputs information indicative of the current position of the vehicle 320 equipped with the navigation apparatus 310. Further, the GPS unit 414 includes various sensors such as a speed sensor, an acceleration sensor, and an angular sensor. Information output from the GPS unit 414 is used in the computation of the current position of the navigation apparatus 310 by the CPU 401. Information indicative of the current position is, for example, information specifying a point with respect to the map information such as latitude/longitude and altitude.

Using programs and data stored to the ROM 402, the RAM 403, the storage unit 405, etc. depicted in FIG. 4, the CPU 401 executes a given program to control the components of the playlist generating apparatus 100 depicted in FIG. 1, whereby functions thereof are implemented.

### (Overview of Content Output by Navigation Apparatus 310)

An overview of content output by the navigation apparatus 310 will be described. The navigation apparatus 310 has a content output function that outputs content such as music. In addition to outputting user designated content in a designated sequence, content output may be by various methods, such as random output where randomly extracted content is output and playlist output where content is output according to a playlist generated in advance.

For playlist output, in addition to a method among these methods, where the user selects content items one by one to generate a playlist, there is a method where the navigation apparatus 310 automatically selects content items to generate a playlist. As one example of such a method, at the navigation apparatus 310, a playlist is generated using a widget running on the navigation apparatus 310.

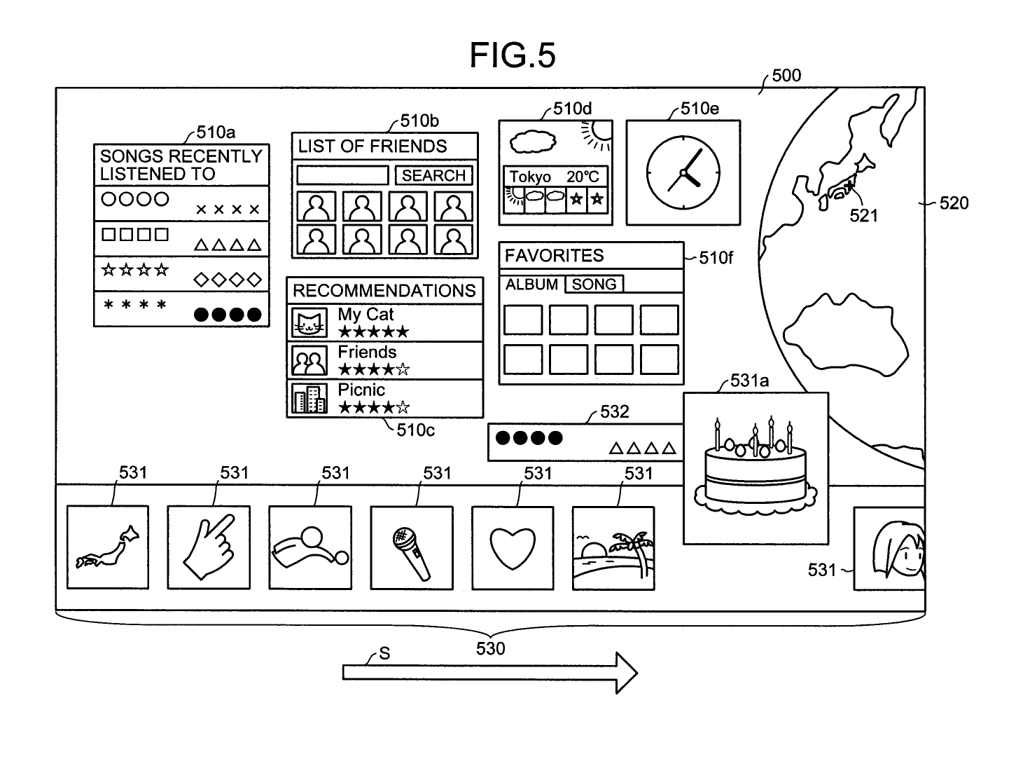

FIG. 5 is one example of an output screen of the navigation apparatus. On the display 411 of the navigation apparatus 310, a content output screen 500 is displayed. The display 411 is a touch panel enabling operation through a touching of displayed icons, hand movements on the display, etc.

The content output screen 500 displays a window 510 (510a to 510f) for a widget running on the navigation apparatus 310. For example, the window 510a is a window of an application for listening to internet radio broadcasts (hereinafter, “radio widget”). Internet radio, for example, delivers automatically selected music of a preliminarily designated genre or artist preferred by the user. The window 510a displays the name of content recently delivered to the user, as well as the name of the artist.

The window 510b is a window displaying SNS information (hereinafter, “SNS widget”). As described, SNS is service for building social networks on the internet 340 or a website, etc., primarily taking the form of a community-modeled, membership based service. Through an SNS, the user us able to exchange messages with other SNS members, post a diary, an evaluation (review) of given content, etc. The window 510b displays a list of SNS members (acquaintances) affiliated with the user.

The window 510c is that of a widget for browsing sites to which moving pictures are posted (hereinafter, “widget for posted moving pictures”). At sites to which moving pictures are posted, the user can freely upload moving pictures, view moving pictures posted by other users, etc. The window 510c displays moving picture rankings based on high evaluations or viewing frequency, for a site to which moving pictures are posted.

The window 510d is that of a weather forecast widget (hereinafter, “weather forecast widget”). The window 510d graphically expresses for to the user, the current local weather conditions (for example, for Tokyo), displays icons, local temperatures, weekly forecasts, etc. Further, the window 510e is that of a time widget (hereinafter, time widget). The window 510e displays an analog clock showing the local time with respect to the user. In addition to a function of displaying the current time, the time widget has a schedule recording function, etc.

The window 510f is that of a content management application widget managing content possessed by the user (hereinafter, “content management widget”). A content management application, for example, has a function of managing content purchased by the user at a website selling content, sharing information concerning liked content between the user and acquaintances, etc. Further the content management application has a function of delivering news (for example, concert information, new album release information, etc.) related to content and artists designated as favorable by the user. The window 510f displays thumbnails of recently purchased content.

Further, in the background of the content output screen 500, an image of a globe (globe-image) 520 is drawn. On the globe-image 520, at a point representing the current position of the user (in the depicted example, Tokyo) and icon 521 is displayed. The display scale of the globe-image 520 can be arbitrarily changed. Further, the position of an acquaintance of the user may be displayed on the globe-image 520. The position of an acquaintance is, for example, acquired via the SNS widget. In this case, the navigation apparatus 310 automatically adjusts the display scale of the globe-image 520 according to the distance between the user and the acquaintance.

In addition to the globe-image 520, background images based on the current position of the navigation apparatus 310, the current time, etc. may be displayed in the background of the content output screen 500. In this case, the type of background images to be displayed may be determined based on priority levels set using a setup screen described hereinafter. Thus, by merely seeing the background images, the user is able to grasp the current setting of the priority level of the widget.

Further, in a lower portion of the content output screen 500, the playlist 530 is displayed. In addition to the content stored in the storage unit 405, the playlist 530 generated by the navigation apparatus 310 includes content delivered by internet radio, content stored on the personal computer 311 at the home 321, etc.

As described, the navigation apparatus 310 generates the playlist 530 based on the widgets running on the navigation apparatus 310 and the priority level set for each widget by the user. Moreover, the navigation apparatus 310 may generate the playlist 530 based on a designated destination and route information. The playlist 530 is configured by thumbnails 531 of the content items on the playlist 530, arranged in order of output from right to left. In other words, corresponding to the progress of the content output according to the playlist 530, the thumbnails 531 move in the direction indicated by arrow S.

Content currently being output is, for example, indicated by a thumbnail that is displayed larger than other thumbnails 531 as depicted by thumbnail 531a, where a display 532 of the title and the artist is also displayed. If the user wishes to change the content to be output, for example, the user touches an arbitrary thumbnail 531, moving it to be conveyed left or right to display the thumbnails 531 of other content. Thus, the thumbnail 531 moves left or right and the thumbnails 531 of other content are displayed. The user touches an arbitrary thumbnail 531 and output of the content begins.

Further, by touching the window 510 of a widget, operation of the widget can be performed. Moreover, by tapping the window 510 of the widget as if double clicking, the screen transitions to the setup screen for setting the priority levels of the widgets.

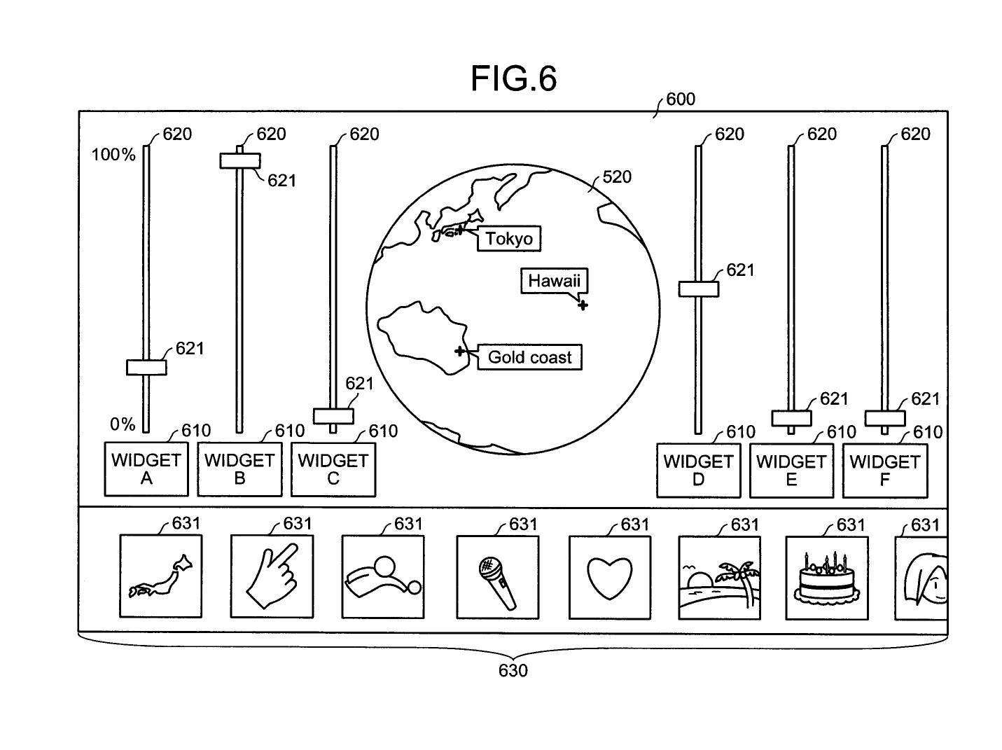

FIG. 6 is a diagram of one example of a setup screen for widget priority levels. A setup screen 600 displays a thumbnail 610 for each widget and adjusting bars 620 to set priority levels for the widgets. In the example depicted in FIG. 6 the priority level of each widget is set using an equalizer. Specifically, when the adjusting bar 620 is at the upper extreme (an upper portion of the setup screen 600), the priority level is 100%, while at the lower extreme (a lower portion of the setup screen 620), the priority level is 0%. The user sets the priority level of a widget by moving a slider 621 to a given priority level.

In the example depicted in FIG. 6, the priority level for widget A is set to approximately 25%, the priority level for widget B is set to approximately 100%, and the priority level for widget D is set to approximately 50%. The priority levels for other widgets are set at 0%. Thus, the navigation apparatus 310 takes information related to widget A, widget B, widget D into consider, excluding that related to widget having a priority level of 0% and generates a playlist. Further, with respect to the widget related information taken into consideration in the generation of a playlist, widget B having a high priority level, is increased by weighting and widget A having a low priority level is decreased by weighting. If the user wishes to change the priority of a widget, the user touches the slider 621 corresponding to the widget for which the priority level is to be changed and the user moves the slider 621 upward or downward. The navigation apparatus 310, upon detecting the change in position of the slider 621, regenerates the playlist based on the priority level after the change in position of the slider 621.

In a lower portion of the setup screen 600, a playlist 630 is displayed. The playlist 630, like the content output screen 500, is configured by the thumbnails 631 of the playlist. If the priority level a widget changes, the playlist changes, resulting in a change in the thumbnails 631 on the playlist 630. Thus, the user is able to know the post-priority-level-change playlist.

In a central portion of the setup screen 600, the globe-image 520 in the background of the content output screen 500 depicted in FIG. 5 is displayed. As depicted in FIG. 6, upon selection of an arbitrary location on the globe-image 520, a playlist can be generated taking into consideration the selected location, resulting in, for example, content popular at the location selected, content of an artist having a connection to the selected location, content for which the plot-setting is the selected location, etc. In addition to a location that is arbitrarily selected by the user, a selected location may be the current location of an acquaintance of the user and the like. In the example depicted in FIG. 6, the Gold Coast in Australia and Hawaii have been selected in addition to Tokyo.

The thumbnails 610 of the widget are, for example, are reductions of the windows 510 of the widgets depicted in FIG. 5. In FIG. 6, for ease in explanation, widget names alone are depicted in the thumbnails.

### (Overview of Playlist Generation)

Next, playlist generation using widget related information will be described. As described, the navigation apparatus 310 generates a playlist using information for widget running on the navigation apparatus 310, where by using information acquired by the widget, the current circumstances of the user can be understood to generate a playlist meeting the needs of the user, from among a vast amount of content.

For example, meteorological information for the current position of the user can be obtained from the weather widget and by using this information, content related to weather conditions (sunny, cloudy, rain, snow, hot, cold) at the current position of the user can be extracted. Further, by using current time and date information acquired from the time widget, content related to the current season (spring, summer, winter, fall, Christmas, cherry blossom season, etc.), time of day (morning, noon, night, sunset, etc.) can be extracted. For example, by using the user's schedule information registered in the time widget, content coordinated with the schedule of the user can be extracted. Specifically, for example, content related to a destination of the user, content correlated with keywords such as “picnic”, “birthday”, etc. can be extracted as well as content of different tempos coinciding with the busyness of the user.

For example, by acquiring from the SNS widget, information concerning content recommended by an acquaintance of the user and the recommended content can be extracted. Further, by acquiring from a widget for browsing sites to which moving pictures are posted, information concerning content posted by an acquaintance, the posted content can be extracted. Additionally, for example, by acquiring from a radio widget, information related to user (or acquaintance) preference and interests, content meeting the preferences and interests can be extracted.

The navigation apparatus 310 combines the information obtained by the widgets and forms a playlist. For example, by combining the content management widget and the SNS widget, from content possessed by the user (information from the content manager widget), content (information from the SNS widget) evaluated highly by an acquaintance can be extracted to generate a playlist. The extent to which each widget is taken into consideration is determined based on the priority levels set through the setup screen depicted in FIG. 6.

Further, since the navigation apparatus 310 can obtain information such as the current position of the user, current destination en route, a route to the destination, etc., the navigation apparatus 310 can extract content items of the playlist, using this information. For example, through a combination of the current position of the user and information from the content management widget, contents for an artist (information from the content management widget) in concert near the current position of the user (information from the navigation apparatus 310) can be extracted to generate a playlist.

The setting of priority levels for widgets using content, such as the content management widget, radio widget, and widget for posted moving pictures, indicate the priority levels of the respective media of the content included on the playlist. For example, if the content management widget has a high priority level, the content possessed by the user is preferentially included in the playlist; if the radio widget has a high priority level, content delivered over the internet is preferentially included in the playlist; and if the widget for posted moving pictures has a high priority level, moving pictures posted to a moving pictures website are preferentially included in the playlist.

### (Procedure of Playlist Generation Processing)

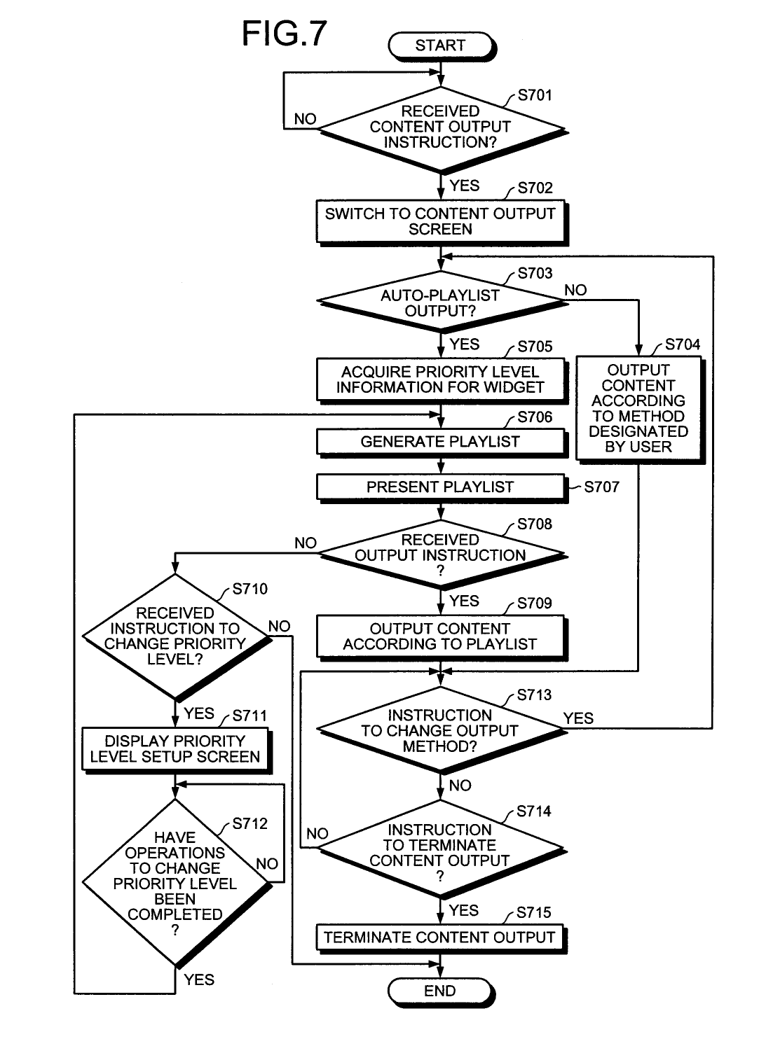

Playlist generation processing executed by the navigation apparatus 310 will be described. FIG. 7 is a flowchart depicting a procedure of the playlist generation processing executed by the navigation apparatus. As depicted in FIG. 7, the navigation apparatus 310 waits for a content output instruction (step S701: NO). Upon a content output instruction (step S701: YES), the navigation apparatus 310 switches the screen of the display 411 to the content output screen (step S702).

Next, the navigation apparatus 310 determines whether the content output method is to be by auto-playlist output (step S703). Auto-playlist output is the output of content according to a playlist generated by the navigation apparatus 310. If auto-playlist output is not to be performed (step S703: NO), content is output according to the method designated by the user (step S704), and the flow proceeds to step S713. A method designated by the user is, for example, content output of a medium designated by the user, content output according to a playlist designated by the user, etc.

On the other hand, if auto-playlist output is to be performed (step S703: YES), the navigation apparatus 310 acquires priority level information for a running widget (step S705) and based on the priority level information, generates a playlist (step S706). Subsequently, the navigation apparatus 310 presents to the user, the playlist generated at step S706 (step S707). Specifically, the navigation apparatus displays on the content output screen, thumbnails of the content items making up the playlist.

The user looks at the playlist (thumbnails of the content items making up the playlist) displayed at step S707) and determines whether to have the content output according to the playlist. The navigation apparatus 310 determines whether there is a playlist output instruction from the user (step S708). If there is a playlist output instruction (step S708: YES), the content is output according to the playlist (step S709).

On the other hand, if there is no playlist output instruction (step S708: NO), the navigation apparatus 310 determines whether there is an instruction to change a widget priority level from the user (step S710). If there is an instruction to change a priority level (step S710: YES), the navigation apparatus 310 displays on the display 411, a priority level setup screen for the widget (step S711) and waits until the user has completed operations to change the priority level (step S712: NO).

Upon completion of operations to change the priority level by the user (step S712: YES), the navigation apparatus 310 returns to step S706 and generates a playlist, based on the changed priority level. The user repeats operations to change the priority level until a desired playlist is obtained. Further, if at step S710, there is no instruction to changed the priority level (step S710: NO), after waiting for a given period, processing under the present flowchart comes to an end.

If content output commences at step S704 or at step S709, the navigation apparatus 310 determines whether there is an instruction to change the content output method in progress (step S713). If there is an instruction to change the content output method (step S713: YES), the navigation apparatus 310 returns to S703 and executes the processing therefrom.

On the other hand, if there is no instruction to change the output method (step S713: NO), the navigation apparatus 310 determines whether there is an instruction to terminate content output (step S714). An instruction to terminate content output may be given by the user, or termination may be determined upon arrival to the destination when the user turns off the power supply to the navigation apparatus 310. If there is no instruction to terminate output (step S714: NO), the flow returns to step and communities on a network. Content output, in addition to the playback of content data recorded to a recording medium, includes the output of content data distributed by streaming on the internet, the output of a broadcast wave transmitted from a broadcast station, etc.

The navigation apparatus 310 is equipped on a vehicle 320, is set by a person in the vehicle 320 and in addition to retrieving a route to a destination and providing route guidance, the navigation apparatus 310 further plays back content data recorded to a recording medium such as a CD, memory card, etc., content data acquired via a network, a broadcast wave of a television broadcast or a radio broadcast, etc. Through the use of the navigation apparatus 310, the user is able to view/listen to desired content while traveling in the vehicle 320.

The personal computer 311 and the stereo system 312 are possessed by and located, for example, at the home of the user. Further, the portable audio player 313 and the cellular telephone terminal 314 are used for content output away from home. Like the navigation apparatus 310, these devices playback content data recorded to a recording medium such as a CD, memory card, etc., content data acquired via a network, a broadcast wave of a television broadcast or a radio broadcast, etc.

S713 and the processing therefrom is repeated. On the other hand, if there is an instruction to terminate output (step S714: YES), the content output is terminated (step S715), ending the processing according to this flowchart.

As described, the navigation apparatus 310 sets priority levels for the applications running on the navigation apparatus 310, and based on the priority levels, generates a playlist. Thus, without designating content item-by-item, the user can obtain a playlist suiting his mood or circumstances at the time by merely setting priority levels for the applications.

For example, if an application is an application having a high priority level and using content, the content used by the application has a high likelihood of being content meeting the preferences of the user at that time. Further, if the application is an application having a high priority level and providing dynamic information, content related to the information provided by the application has a high likelihood of meeting the preferences of the user at that time. The navigation apparatus 310, in generating a playlist, without direct designation of keywords by the user, elicits a setting of priority levels with respect to applications, enabling generation of a playlist drawing out non-obvious (ambiguous) needs of the user.

Further, as application related information, by using information in a window used by the user, real-time information related to preferences and the lifestyle of the user, daily plans, etc, can be automatically obtained, enabling generation of a suitable playlist from user needs. Further, upon generation of the playlist, by using position information for the navigation apparatus 310, a playlist meeting changes in the circumstances of the user in real-time can be generated.

The playlist generating method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the recording medium, and executed by the computer. The program may be a transmission medium that can be distributed through a network such as the Internet.

### EXPLANATIONS OF LETTERS OR NUMERALS

100 playlist generating apparatus
101 application information acquiring unit
102 setting unit
103 generating unit
104 position information acquiring unit
110 information processing terminal

1-14. (canceled)

15. A playlist generation apparatus that extracts given content items from a content group and generates a playlist, the apparatus comprising:
an application information acquiring unit that acquires information related to an application running on an information processing terminal possessed by a user viewing/listening to the content items;
a setting unit that receives setup-input for setting a priority level, for each application running on the information processing terminal; and
a generating unit that based on the set priority levels and the information related to an application running, extracts from the content group, the content items to constitute the playlist and generates the playlist.

16. The playlist generating apparatus according to claim 15, wherein
the application is an application using the content items,
the application information acquiring unit acquires information related to the content items used by the application, and
the generating unit preferentially uses the information related to the content items used by the application having a high priority level, to generate the playlist.

17. The playlist generating apparatus according to claim 16, wherein
the application is a content management application that manages content items possessed by the user,
the application information acquiring unit acquires at least one type of information among viewing/listening frequency information for the possessed content items, user evaluation information for the possessed content items, procurement route information, and procurement-period information.

18. The playlist generating apparatus according to claim 16, wherein
the application is a viewing/listening application for viewing/listening to an internet broadcast, and
the application information acquiring unit acquires at least one type of information among information concerning an internet broadcast currently in progress, information concerning content delivered in the past via an internet broadcast, and user evaluation information concerning internet radio delivered content.

19. The playlist generating apparatus according to claim 16, wherein
the application is a viewing/listening application for viewing/listening to content posted on the internet, and
the application information acquiring unit acquires at least one type of information among evaluation information concerning the posted content, playback frequency information for the posted content, and information concerning keywords correlated with the posted content.

20. The playlist generating unit according to claim 15, wherein
the application is an application providing dynamic information that changes dynamically,
the application information acquiring unit acquires the dynamic information provided by the application, and
the generating unit preferentially extracts the content item related to the dynamic information provided by the application.

21. The playlist generating apparatus according to claim 20, wherein
the application is an application for accessing a social network service that builds a network with other persons through the internet, and
the application information acquiring unit acquires at least one type of information among content information introduced to the user by a person in the social network and content information introduced to a person in the social network by the user.

22. The playlist generating apparatus according to claim 20, wherein
the application is an application providing at least one type of information among current position information concerning the user, local weather information for the current position of the user, current local time information for the user, and schedule information for the user, and
the application information acquiring unit acquires the information provided by the application.

23. The playlist generating apparatus according to claim 20, wherein
the application is an application providing at least one type of information among current position information concerning an acquaintance of the user, local weather information for the current position of the acquaintance, current local time information for the acquaintance, and schedule information for the acquaintance, and
the application information acquiring unit acquires the information provided by the application.

24. The playlist generating apparatus according to claim 15, further comprising a position information acquiring unit that acquires position information concerning the playlist generating apparatus, wherein
the generating unit generates the playlist using the position information and the information related to the application.

25. The playlist generating apparatus according to claim 15, wherein the application is a widget running on the information processing terminal.

26. A playlist generating method of extracting given content items from a content group and generating a playlist at a playlist generating apparatus, the playlist generating method comprising:
acquiring information related to an application running on an information processing terminal possessed by a user viewing/listening to the content items;
receiving setup-input for setting a priority level, for each application running on the information processing terminal; and
extracting from the content group and based on the set priority levels and the information related to an application running, the content items to constitute the playlist in generating the playlist.

27. A non-transitory, computer-readable recording medium storing therein a playlist generating program causing a computer to execute:
acquiring information related to an application running on an information processing terminal possessed by a user viewing/listening to the content items;
receiving setup-input for setting a priority level, for each application running on the information processing terminal; and
extracting from the content group and based on the set priority levels and the information related to an application running, the content items to constitute the playlist in generating the playlist.
